(19) United States
(12) Patent Application Publication
(10) Pub. No.: US 2008/0168006 A1
(43) Pub. Date: Jul. 10, 2008

(54) METHOD AND APPARATUS FOR RETIREMENT INCOME PLANNING

(76) Inventors: ROBERT MERTON, Cambridge, MA (US); ROBERTO MENDOZA, New York, NY (US); PETER HANCOCK, Rye, NY (US)

Correspondence Address: PATTERSON & SHERIDAN, LLP, 595 Shrewsbury Avenue, Suite 100, Shrewsbury, NJ, 07702, US

(21) Appl. No.: 11/966,169

(22) Filed: Dec. 28, 2007

Related U.S. Application Data
(60) Provisional application No. 60/883,300, filed on Jan. 3, 2007.

(51) Int. Cl. G06Q 40/00

(52) U.S. Cl. 705/36 R

(57) ABSTRACT

Embodiments of the invention generally provide a method and apparatus for retirement income planning. One embodiment of a method for defining an income stream for an individual includes allocating, in response to receiving lifestyle or personal preferences from the individual, equity belonging to the individual among one or more investments and defining a determinable income stream payable to the individual over the lifetime of the individual in accordance with the allocations of equity.

### FIELD OF THE INVENTION

The present invention generally relates to retirement planning, and more particularly relates to planning an income stream for an individual to fund the individual's desired standard of living during retirement.

### BACKGROUND OF THE INVENTION

Most working individuals have retirement plans in place to support themselves financially when they retire from the workforce. Such plans generally manage and/or invest the individual's assets (sometimes including at least a portion of the individual's regular income) in order to provide financial security when the individual retires and no longer receives a regular income.

Recently, many retirement plans have shifted from defined-benefit type plans, in which a plan sponsor is exposed to investment risk, inflation risk, longevity risk and portfolio management for groups of individuals in order to minimize risk, to defined-contribution type plans, which give the individual more control and discretion in the investment of funds, but come with increased risk. Unfortunately, typical defined contribution type plans often fail to provide the individual with the resources and knowledge necessary to make informed investment decisions.

Many individuals can easily visualize their desired standard of living upon retirement, but are unsure of the necessary steps to take in order to secure this desired standard. Moreover, many individuals find available investment products, such as investment contracts and annuities, complicated and intimidating, making retirement planning a daunting task.

Therefore, there is a need in the art for a method and apparatus for retirement income planning.

### SUMMARY OF THE INVENTION

Embodiments of the invention generally provide a method and apparatus for retirement income planning. One embodiment of a method for defining an income stream for an individual includes allocating, in response to receiving lifestyle or personal preferences from the individual, equity belonging to the individual among one or more investments and defining a determinable income stream payable to the individual over the lifetime of the individual in accordance with the allocations of equity.

### BRIEF DESCRIPTION OF THE DRAWINGS

So that the manner in which the above recited embodiments of the invention are attained and can be understood in detail, a more particular description of the invention, briefly summarized above, may be had by reference to the embodiments thereof which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram illustrating one embodiment of a system for planning retirement income, according to the present invention;

FIG. 2 is a flow diagram illustrating one embodiment of a method for planning an individual's retirement income stream, according to the present invention;

FIG. 3 is a flow diagram illustrating one embodiment of a method for allocating an individual's assets among one or more investments, according to the present invention; and

FIG. 4 is a high level block diagram of the present retirement planning tool that is implemented using a general purpose computing device.

To facilitate understanding, identical reference numerals have been used, where possible, to designate identical elements that are common to the figures.

### DETAILED DESCRIPTION

Embodiments of the invention generally provide a method and apparatus for retirement income planning (e.g., for use in planning an individual retirement income stream). In particular, the present invention integrates a plurality of financial drivers in order to assist an individual in managing his or her assets and targeted needs (e.g., income, savings, home, medical, etc.) to ensure a desired standard of living, both while working and while retired. In one embodiment, a retirement plan is created for the individual that substantially mimics traditional pension fund or defined benefit plans. That is, defined benefit-like benefits (e.g., specific benefit amounts, minimized risk) are provided under a defined contribution-like structure (e.g., more individual control). Thus, embodiments of the present invention scale traditional large-scale approaches to the individual level.

In short, the present invention assists a user in determining the minimum standard of living he or she is willing to tolerate in retirement, estimating the cost of that minimum standard of living (factoring in a long lifetime and inflation), estimating future income (e.g., from Social Security, pensions, part-time work and other sources), and ensuring that the minimum standard of living will always be achieved (afforded) by purchasing an annuity to fill the gap between the estimated future income and the estimated expenses associated with the minimum standard of living.

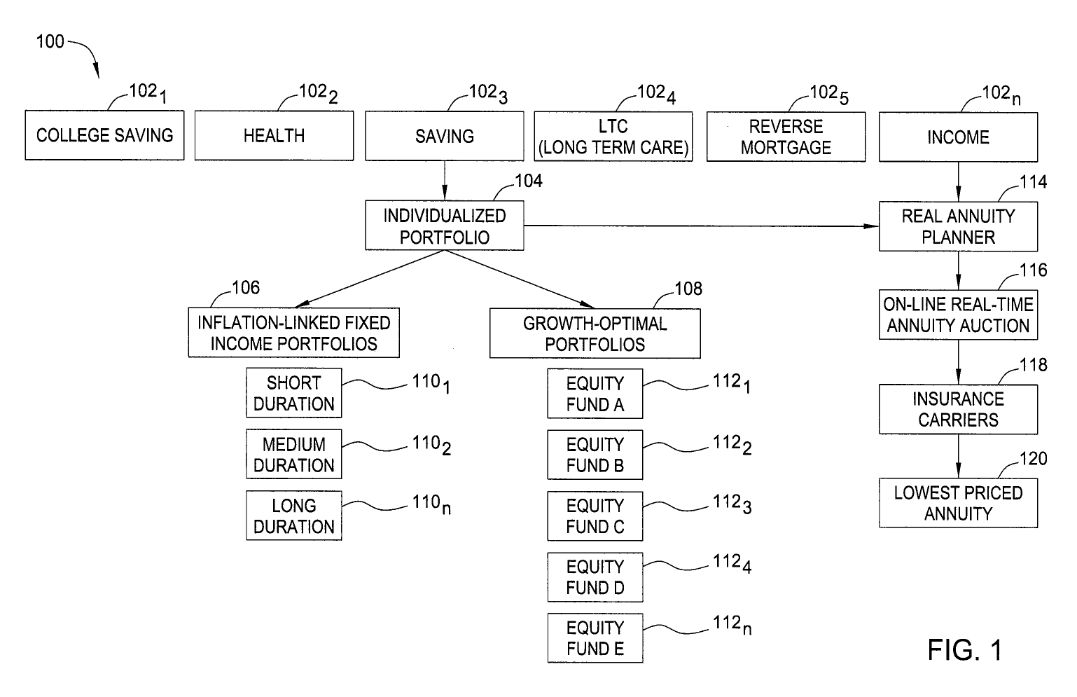

FIG. 1 is a block diagram illustrating one embodiment of a system 100 for planning retirement income, according to the present invention. In one embodiment, the system 100 is implemented in an Internet-based platform. The system 100 comprises a plurality of financial drivers 102₁-102ₙ (hereinafter collectively referred to as “drivers 102”), each driver 102 configured to represent and manage a targeted need. The drivers 102 are integrated such that they may share information among themselves in order to present a complete picture of an individual's financial situation. Each of the drivers 102 may be further associated with one or more educational tools (e.g., hyperlinks to frequently asked questions, informational articles, etc., not shown) to assist a user in making informed decisions as they relate to the user's goals and the functionalities of the particular driver 102.

In one embodiment, the drivers 102 include one or more of the following: a college savings driver 102₁ (e.g., for financing higher education needs), a health or medical needs driver 102₂ (e.g., for bridging an employer-provided health plan and Medicare/Medicaid), a savings driver 102₃ (e.g., for managing savings to meet retirement predefined goals), a long term care driver 102₄ (e.g., for funding long-term medical treatment), a reverse mortgage driver 102₅ (e.g., for deriving equity from an owned home) and a pension driver 102ₙ (e.g., for funding an income stream for retirement).

In one embodiment, the college savings driver 102₁ is configured to finance higher education needs (e.g., tuition, books, room and board, etc.).

In one embodiment, the health needs driver 102₂ is configured for financing health-related costs that are not covered by an existing health care plan, e.g., in the period between the expiration of an employer-provided health care plan and availability of a government-provided health care plan, such as Medicare or Medicaid.

In one embodiment, the savings driver 102₃ is configured for managing the individual's “accumulation phase” of retirement planning, where the accumulation phase is substantially equivalent to the individual's working years (e.g., where assets are accumulated). The accumulation phase is managed such that the individual's savings meet targeted retirement goals. That is, assets are accumulated (e.g., by allocating funds among investments during the individual's working years) in a manner to generate sufficient funds to finance a desired standard of living at the time of retirement (e.g., financed by an annuity to be purchased at least in part with a lump sum, as described in U.S. patent application Ser. No. 11/531,989, filed Sep. 14, 2006, which is herein incorporated by reference in its entirety).

The savings driver 102₃ further comprises an individualized portfolio 104 reflecting investments of the individual's retirement savings. The individualized portfolio 104 is further divided into a fixed income portfolio 106 and a growth-optimal portfolio 108.

In one embodiment, the fixed income portfolio 106 comprises a plurality of inflation-linked fixed income portfolios 110₁-110ₙ (hereinafter collectively referred to as “fixed income portfolios 110”). For example, the fixed income portfolio 106 may comprise a short-duration fixed income portfolio 110₁, a medium-duration fixed income portfolio 110₂ and a long-duration fixed income portfolio 110ₙ. The goal of each fixed income portfolio 110 is to invest the individual's resources in a manner to deliver a sum of money sufficient to purchase an annuity that will provide a minimum retirement income (e.g., X number of dollars per year). Each of the fixed income portfolios 110 comprises inflation-linked bonds combined with nominal government bonds and inflation derivatives or other appropriate investment vehicles. The duration and the convexity of a particular fixed income portfolio 110 hedge the real interest rate exposure. In further embodiments, the fixed income portfolio 106 comprises a synthetic deferred real annuity.

In one embodiment, the growth-optimal portfolio 108 comprises a dynamically managed set of funds in different asset classes, for example, in a plurality of diversified global equity portfolios 112₁-112ₙ (hereinafter collectively referred to as “global equity portfolios 112”). The managed set of funds can be created using actual index funds or using derivatives, and the choice of index can also be based on cost. Each global equity portfolio 112 comprises a combination of global equity, fixed income and other assets. For example, the global equity portfolios 112 may include one or more of: a growth-optimal commodity fund, a growth-optimal corporate bond fund, a growth-optimal developed fund, a growth-optimal emerging market funds, a growth-optimal real estate fund, and an alpha fund. In one embodiment, the managed set of funds can grow or diminish over time as the user wants more or less funds managed in the growth portfolio 108. Thus, the goal of the growth optimal portfolio 108 is to invest the individual's resources in a manner to provide a desired retirement income (i.e., at least as great as the minimum retirement income that the fixed income portfolio 110 strives to provide).

The savings driver 102₃ is configured to allocate the individual's retirement savings among the portfolios 104, 106, 108, 110 and 112, based upon age and upon a stated risk preference, where the magnitude of the stated risk preference relates, inversely, to the value of the minimum desired standard of living (e.g., the lower the minimum, the greater the risk that is taken in managing the portfolio).

In one embodiment, the long term care driver 1024 is configured for funding long-term medical treatment that is not covered by an existing health care plan.

In one embodiment, the reverse mortgage driver 102₅ is configured for deriving equity from an owned home, e.g., by taking out a loan against the home that does not need to be paid back for as long as the individual resides in the home. The loan amount may be used, for example, to fund some of the other financial drivers 102 (e.g., to purchase long-term care, Medicare riders, annuities, etc.).

In one embodiment, the pension driver 102ₙ is configured for managing the individual's “payout phase” of retirement planning, e.g., by constructing and funding an income stream for retirement. In particular, the pension driver 102ₙ assists an individual in measuring his or her needs and in planning out a reliable post-retirement income stream to meet those needs. For example, the pension driver 102ₙ may purchase an annuity using assets accumulated during the accumulation phase, where the annuity provides a defined benefit level or sum of money during each year of the individual's retirement. Alternatively, the pension driver 102ₙ may purchase annuities using funds provided by a reverse mortgage or other qualified fund sources (e.g., personal savings, individual retirement accounts, etc.).

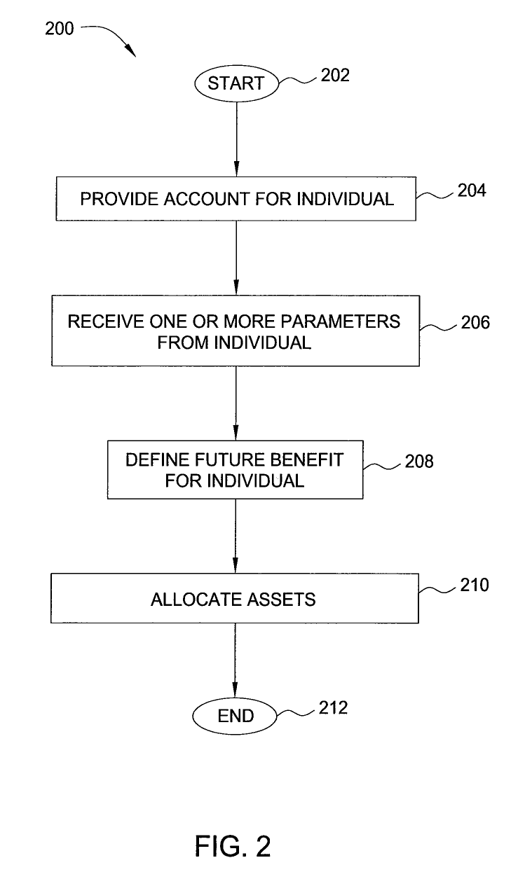

To this end, the pension driver 102ₙ comprises a real annuity planner 114 that assists the individual in determining the size of and in purchasing an annuity to fund the post-retirement income stream. One embodiment of the real annuity planner 114 is discussed in further detail below with respect to FIG. 2. As discussed, the real annuity planner 114 is linked to an on-line, real-time annuity auction 116 that enables the individual to compare the prices of similar institutionally priced annuities provided by a plurality of insurance carriers 118. Typically, the real annuity planner 114 will assist the individual in identifying and purchasing the lowest priced annuity 120 that meets his or her needs, as determined by the real annuity planner 114. In one embodiment, the real annuity planner 114 examines both real and nominal variable annuities (including, for example, equity-indexed, inflation-linked annuities). As described in further detail below, the real annuity planner 114 may be a stand-alone module as well as a module that is linked directly to the pension driver 102₃.

FIG. 2 is a flow diagram illustrating one embodiment of a method 200 for planning an individual's retirement income stream, according to the present invention. The method 200 may be implemented, for example, in an asset allocator that is integrated in the savings driver 102₃ and distributes an individual's funds among the fixed income portfolio 106 and growth optimal portfolio 108. Thus, the method 200 aids in defining the accumulation phase of an individual's retirement plan and in meeting the minimum and desired retirement income levels that the individual specifies.

The method 200 is initialized at step 202 and proceeds to step 204, where the method 200 provides an individual account for the individual. That is, the individual is provided with a discrete user account in which to manage his or her savings.

In step 206, the method 200 receives one or more parameters from the individual regarding his or her retirement income needs and contribution preferences. These parameters may be newly provided, or may comprise updates or changes to previously provided parameters (e.g., accounting for changes to work-life consumption and retirement period consumption). In one embodiment, the parameters provided by the individual comprise at least one of: the individual's target or desired retirement income level, the individual's minimum acceptable retirement income level (which serves as a risk level or constraint), the individual's desired retirement age and the individual's desired contribution (savings) rate.

In step 208, the method 200 defines a future benefit for the individual, based on the parameters provided. In one embodiment, the future benefit comprises an inflation-protected, definitely determinable annuity that is payable to the individual over a period of years (e.g., for life, after the individual retires). In one embodiment, the future benefit is defined in accordance with an allocation of the individual's assets among one or more investments, which is computed based on the parameters provided in step 206.

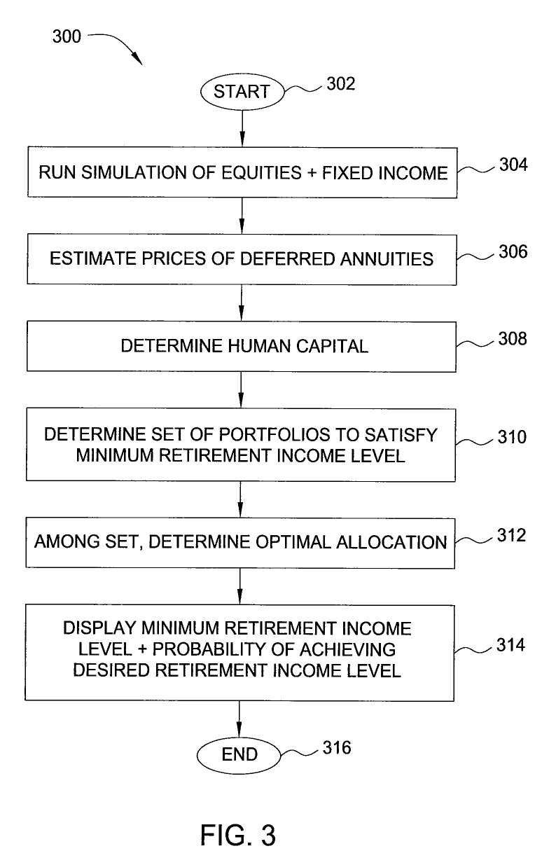

In step 210, the method 200 allocates the individual's assets among a plurality of available investments in a manner that aims to secure the defined future benefit. As described above, the allocation takes into account the parameters provided in step 206. One embodiment of a method for performing asset allocation based on these parameters is discussed in further detail with respect to FIG. 3. The method 200 then terminates in step 212.

The method 200 thereby manages the investment of the individual's assets to target a desired level of real retirement income, subject to a risk constraint (minimum retirement income). The individual is provided with a known retirement benefit (e.g., in a manner similar to a traditional defined benefit plan), while also being allowed control over the circumstances of his or her retirement via an individual account (e.g., in a manner similar to a traditional defined contribution plan). The individual's retirement preferences, which comprise relatively intuitive concepts such as retirement income goals, retirement age and annual savings rate, guide the investment of his or her assets, without requiring the individual to make such explicit investment decisions him or herself. Moreover, balance sheet liability and risk to the individual's employer is minimized.

In one embodiment, the method 200 employs a combination of traditional, market-proven technologies applied in an innovative setting and in an integrated manner. In one embodiment, these technologies are applied on a periodic basis (e.g., monthly) to achieve optimal allocation of the individual's assets based on retirement income goals and market movements.

The method 200 is executed within an economic environment that is specified by six independent random variables: interest rates, equity returns, mortality statistics influencing the pricing of annuities, inflation, wages, and life events (e.g., marriage, baby, etc.). These variables are modeled as described below.

In one embodiment, the spot rate of interest follows a process such as that described by Cox et al. in “A Theory of the Term Structure of Interest Rates”, Econometrica, 53, 2, 1985, where:

drₜ=κ ( r̅−rₜ)dt+σᵣ\sqrt{rₜdWₜ^{B}} (EQN. 1)

where κ is the speed of mean reversion, r̅ is the long-term tendency for the spot rate, σᵣ is a volatility parameter and dWₜ^{B} is a standard Brownian motion. Those skilled in the art will appreciate that EQN. 1 represents only one potential model of the spot rate of interest; other equivalent models may also be applied in the context of the present invention. Based on EQN. 1, the price at time t of a bond maturing at time v, denoted B(t,v), is:

B(t, v)=C₁(t, v)e^{[-r}^{ₜ}^{C}^{₂}^{(t,v)]} (EQN. 2)

in which

$$\begin{matrix}{C}_{1} ( t , v ) = {[ \frac{φ {e}^{\{ ( κ + {θ}^{B} φ ) ( v - t ) / 2 \}}}{\frac{( κ + {θ}^{B} + φ )}{2} ( {e}^{\{ φ ( v - t ) \}} - 1 ) + φ} ]}^{2 κ \overline{r} / {σ}_{r}^{2}} & ( EQN . 3 ) \\ and & \\ {C}_{2} ( t , v ) = \frac{( {e}^{\{ φ ( v - t ) \}} - 1 )}{\frac{κ + {θ}^{B} + φ}{2} ( {e}^{\{ φ ( v - t ) \}} - 1 ) + φ} & ( EQN . 4 )\end{matrix}$$

φ=\sqrt{(θ^{B}+κ)²+2σ²}, and θ^{B} is a constant parameter based on which the market price of interest rate risk at time t equals

$${θ}^{B} ( r , t ) = \frac{{θ}^{B} \sqrt{{r}_{t}}}{{σ}_{r}} ,$$

as discussed, for example, by Baz et al. in “Financial Derivatives”, Cambridge University Press, 2004. Furthermore, bond prices obey

$$\frac{d B ( t , v )}{B ( t , v )} = [ \frac{\begin{matrix}\frac{\partial B ( t , v )}{\partial {r}_{t}} κ ( \overline{r} - {r}_{t} ) + \frac{\partial B ( t , v )}{\partial t} + \\ \frac{1}{2} \frac{{\partial }^{2} B ( t , v )}{\partial {r}_{t}^{2}} {σ}_{r}^{2} {r}_{t}\end{matrix}}{B ( t , v )} ] dt - [ \underbrace{( - \frac{\frac{\partial B ( t , v )}{\partial {r}_{t}}}{B ( t , v )} )}_{duration = D ( t , v )} {σ}_{r} \sqrt{{r}_{t}} ] {dW}_{t}^{B} \qquad ( EQN . 5 )$$

In one embodiment, the present invention takes positions in equities only in the form of a world equity index. This world equity fund is assumed to follow:

dSₜ=Sₜ(μdt+σdWₜ^{S}) (EQN. 6)

where σ is the volatility of the index, μ is the instantaneous expected rate of return and dWₜ^{S} is a standard Brownian motion increment independent of dWₜ^{B}. Those skilled in the art will appreciate that although EQN. 6 describes the behavior of a single fund, an actual portfolio may include a plurality of such funds.

Mortality tables are assumed to follow a stochastic version of the Gompertz law, in which the instantaneous force of death for age s at time t is given by

$$h + \frac{1}{b} {e}^{( \frac{s - {m}_{t}}{b} )}$$

and mₜ is the current median age of death at time t, which evolves stochastically over time. Instantaneous probabilities of survival at time t from age T_{R} to any future age v are given by:

$${\prod }_{t} ( {T}_{R} , v ) = {e}^{\{ - {\int }_{{T}_{R}}^{v} ( h + \frac{1}{b} {e}^{( \frac{s - {m}_{t}}{b} )} ) d s \}} \qquad ( EQN . 7 )$$

The individual will participate in the plan defined for him or her from time t=0 to time t=T, where time T_{R} ε (0,T) represents the time at which the individual reaches his or her desired retirement age. The individual's constant flow of earnings (income) is defined as ω, while the individual's desired contribution level (i.e., a constant flow of savings), including an employer match (if any), is defined as s(ω). The individual's minimum acceptable retirement income level (risk level) is defined as A^{M}(ω), while the individual's desired retirement income level is defined as A^{D}(ω), and both values are assumed not to change over the horizon [0, T_{R}].

FIG. 3 is a flow diagram illustrating one embodiment of a method 300 for allocating an individual's assets among one or more investments, according to the present invention. The method 300 may be implemented, for example in accordance with step 208 of the method 200, described above. In one embodiment, time is discretized in the implementation of the method 300.

The method 300 is initialized at step 302 and proceeds to step 304, where the method 300 runs a simulation of the individual's equities and fixed income over his or her working years. In one embodiment, the data necessary to run the simulation is provided by the individual in step 206 of the method 200.

In step 306, the method 300 finds a distribution of annuity prices (e.g., using a distribution of fixed income). That is, the method 300 estimates the likely prices of deferred annuities (at the time of the individual's desired retirement), based on observable data. In one embodiment, bond prices for all maturities B(t,v) are obtained, and current mortality tables Πₜ(T_{R},(T_{R}−t)+v) are used to obtain model-based prices for immediate annuities at time t, paying the minimum acceptable retirement income level, A^{M}(ω), to its holder for the (T−T_{R}) years ahead:

$${A}^{M} ( ω ) Q ( t ) ≡ \underbrace{{A}^{M} ( ω )}_{user input} { \sum }_{t}^{t + ( T - {T}_{R} )} [ \underbrace{B ( t , v )}_{bond market data} \times \underbrace{{\prod }_{l} ( {T}_{R} , ( {T}_{R} - t ) + v )}_{actuarial data} ] \qquad ( EQN . 8 )$$

In step 308, the method 300 determines the human capital (i.e., the individual's likely contributions). The individual must have at least

$${{\underbrace{{A}^{M} ( ω )}}_{user input}}_{ } {\sum }_{{T}_{R}}^{T} [ \underbrace{B ( t , v )}_{bond market data} \times \underbrace{{E}_{t} [ {\prod }_{{T}_{R}} ( {T}_{R} , v ) ]}_{actuarial data} ] \qquad ( EQN . 9 )$$

at time T_{R} in order to meet the goal of consuming the minimum acceptable retirement income level, A^{M}(ω) in retirement.

In addition to the initial financial wealth x×>0 deposited in the account at inception, the individual will contribute the constant flow s(ω) to the account. The present value of these future contributions at time t−0 is:

$$s ( ω ) {\sum }_{t}^{{T}_{R}} B ( t , v ) \qquad ( EQN . 10 )$$

Based on EQNs. 9 and 10, the individual's minimum acceptable retirement income level is deemed achievable only if the budget constraint:

$$x + s ( ω ) {\sum }_{l}^{{T}_{R}} B ( t , v ) > {A}^{M} ( ω ) {\sum }_{I}^{{T}_{R}} B ( t , v ) {E}_{t} [ {\prod }_{{T}_{R}} ( {T}_{R} , v ) ] \qquad ( EQN . 11 )$$

is satisfied. Assuming that the budget constraint in EQN. 11 is characterized by a strict inequality, a fraction γε(0,1)of all future contributions is set aside for the goal of reaching the individual's minimum acceptable retirement income level such that:

$$γ = \frac{\begin{matrix}[ \underbrace{{A}^{M} ( ω )}_{user input} {\sum }_{{T}_{R}}^{T} [ \underbrace{B ( t , v )}_{bond market data} \times \underbrace{{E}_{t} [ {\prod }_{{T}_{R}} ( {T}_{R} , v ) ]}_{actuarial data} ] ] - \\ \underbrace{{X}_{l}^{M}}_{value of minimum portfolio}\end{matrix}}{\underbrace{s ( ω )}_{user input} {\sum }_{t}^{{T}_{R}} [ {\underbrace{B ( t , v )}}_{bond market data} ]} \qquad ( EQN . 12 )$$

Proper hedging of interest rate risk requires that the bond investment in the individual's minimum acceptable retirement income level portfolio (e.g., fixed income portfolio 106) satisfy:

$$D ( t , L ) = \frac{\begin{matrix}{A}^{M} ( ω ) {\sum }_{I}^{{T}_{R}} ( B ( t , v ) D ( t , v ) {E}_{l} [ {\prod }_{{T}_{R}} , v ] ) - \\ {γ}_{t} ( ω ) {\sum }_{t}^{{T}_{R}} B ( t , v ) D ( t , v )\end{matrix}}{{X}_{t}^{M}} \qquad ( EQN . 13 )$$

if πₜ^{B} is chosen to be equal to one. This is equivalent to a statement that duration matching is the required investment policy for this portfolio. In one embodiment, the portfolio is invested in long bonds whose maturities, L, are chosen such that the duration, D(t, L), of the portfolio is equal to the duration of the net liability.

Armed with the human capital, the method 300 proceeds to step 310 and determines a set of portfolios that will satisfy the minimum retirement income level being entirely in fixed income. That is, the method 300 determines what fixed income funds will likely buy the annuity to secure the minimum retirement income level. Then in step 312, the method 300 determines, from among the set of portfolios identified in step 310, the optimal allocation that achieves the desired retirement income level with the highest probability and lowest variance.

The probability of achieving the target or desired retirement income level is the probability that:

$${X}_{T}^{D} = \underbrace{{X}_{t}^{D}}_{value of desired portfolio} \underbrace{{e}^{\{ ( μ - \frac{1}{2} {σ}^{2} ) ( {T}_{R} - t ) + σ ( {W}_{{T}_{R}}^{S} - {W}_{t}^{S} ) \}}}_{random variable} + ( 1 - {γ}_{t} ) \underbrace{s ( ω )}_{user input} {\sum }_{t}^{{T}_{R}} [ \underbrace{{e}^{\{ ( μ - \frac{1}{2} {σ}^{2} ) ( {T}_{R} - v ) + σ ( {W}_{{T}_{R}}^{S} - {W}_{t}^{S} ) \}}}_{random variable} ] \qquad ( EQN . 14 )$$

be greater than

$$[ {A}^{D} ( ω ) - {A}^{M} ( ω ) ] \times {\sum }_{{T}_{R}}^{T} [ B ( {T}_{R} , v ) \times {\prod }_{{T}_{R}} ( {T}_{R} , v ) ] \qquad ( EQN . 15 )$$

The portion of the portfolio invested in equity is set to maximize the portion of the portfolio dedicated to the desired retirement income level. In one embodiment, this involves investing between equity and fixed income funds so that the probability of achieving the desired retirement income level is maximized with the smallest possible variance. This involves moving the individual's portfolio entirely in fixed income when the combination of the present-day value of contributions and the current balance will achieve the desired retirement income level.

In another embodiment, the probability of successfully achieving the target or desired retirement income level, A^{D}(ω), is calculated by approximating the density function for the terminal value of the individual's equity holdings (a sum of correlated lognormal random variables) via the reciprocal gamma distribution. This approximate closed-form expression allows the savings driver 102₃ to calculate the probability of achieving the target or desired retirement income level, A^{D}(ω), given the minimum retirement income level and the target or desired retirement income level. In an alternative embodiment, the approximate closed-form expression allows the savings driver 102₃ to solve for a desired retirement income target, conditioned on; (1) a probability of success (e.g., x %); and (2) a minimum retirement income level.

However,

$${\sum }_{{T}_{R}}^{T} [ B ( {T}_{R} , v ) \times {\prod }_{{T}_{R}} ( {T}_{R} , v ) ]$$

is the price of an immediate annuity starting at time T_{R}, which is a random variable at time t. In one embodiment, the current price of an immediate annuity (i.e., an observable market price) is used as a proxy so that the reported probability is:

Pr(X_{T}^{D}≧[A^{D}(ω)−A^{M}(ω)]×MQ(t)|Xₜ^{D}) (EQN. 16)

In one embodiment, this reported probability is the result of a standard Monte Carlo simulation. In another embodiment, the reported probability is the result of an approximate closed-form solution, such as that described by Turnbull and Wakeman in “A Quick Algorithm for Pricing European Average Options”, Journal of Financial and Quantitative Analysis, 26, 3, 1991.

Whenever user inputs are changed at some time, t, EQN. 12 is used to determined a new Y value for the fraction of future contributions required to achieve the new minimum acceptable retirement income level, and the probabilities of successfully achieving the target or desired retirement income level is recalculated in accordance with EQNs. 14 and 16, subject to the present initial condition Xₜ^{D}, the current value of the equity portfolio already held within the portfolio for the target or desired retirement income level at time t.

Steps 302-312 are substantially transparent to the user; however, the method 300 displays (e.g., visually) the minimum retirement income level and the probability of achieving the desired retirement income level to the individual in step 314. The method 300 then terminates in step 316.

In one embodiment, the allocation of the individual's equity among one or more portfolios designed to strive for the desired retirement income is achieved implementing a version of the portfolio selection method described by Black et al. in “Asser Allocation: Combining Investor Views with Market Equilibrium”, Journal of Fixed Income, 1991 and in “Global Portfolio Optimization”, Financial Analysts Journal, 1992. In one embodiment, subjective beliefs about expected returns are provided by the output of an optimal investment model (under a regime of stochastic volatility) described by Chacko et al. in “Dynamic Consumption and Portfolio Choice with Stochastic Volatility in Incomplete Markets”, Review of Financial Studies, 2005.

In particular, the model comprises two asset classes: (1) developed world (DW) equity; and (2) emerging markets (EM) equity, both of which are combined to comprise a world (W) equity portfolio. In one embodiment, each asset has returns that are normally distributed such that realized returns r˜N(ψ, Σ) with the ψ vector of expected returns and Σ the returns' variance-covariance matrix:

$$Σ = \begin{matrix}Var ( {r}^{EM} ) & Cov ( {r}^{EM} , {r}^{DW} ) \\ Cov ( {r}^{EM} , {r}^{DW} ) & Var ( {r}^{DW} )\end{matrix} \qquad ( EQN . 17 )$$

Equilibrium risk premia, P, are determined by:

P=λΣδ_{eq} (EQN. 18)

where λ is the representative agent's risk aversion parameter and δ_{eq}=[δ_{eq}^{DW} δ_{eq}^{E}]′ are the equilibrium portfolio weights or relative market capitalization. The risk aversion parameter, λ, is estimated by inversion of the equilibrium condition,

$$λ = \frac{E ( {r}^{W} ) - {r}_{f}}{Var ( {r}^{W} )} \qquad ( EQN . 19 )$$

The solution to EQN. 19 is used to estimate P^{DW} and P^{EM}, via EQN. 18. Based on the above, the Bayesian prior is that ψ are centered at equilibrium levels empirically estimated above, so that actual expected excess returns are ψ=P+ε_{eq}, where εₑ˜N(0,TΣ), and T measures the uncertainty of the empirical equilibrium prior (T=0.75 in the present exemplary case). The framework proposed by Black et al. offers a methodology to combine the equilibrium priors with subjective views, which in one embodiment are provided by the Chacko et al. model. More specifically, with views regarding the DW and EM portfolios expressed as

Q=λΩδ_{cv} (EQN. 20)

where Ω is the variance-covariance matrix obtained from the shorter time series (Σ that is estimated with twelve years' worth of monthly returns, while Ω is estimated on the last two years' worth of monthly returns) used to derive δ_{cv}=[δ_{cv}^{DW} δ_{cv}^{E}]′, which are normalized (so that δ_{cv}^{DW}+δ_{cv}^{E}=1, see below) portfolio weights derived in accordance with Chacko et al. The Bayesian posterior is that expected returns are distributed r˜N(\tilde{μ},\tilde{M}⁻¹) where

\tilde{μ}=[(τΣ)⁻¹Ω⁻¹]⁻¹[(τΣ)⁻¹P+Ω⁻¹Q] (EQN. 21)

and its variance-covariance matrix is

\tilde{M}⁻¹=[(τΣ)⁻¹=Ω⁻¹]⁻¹ (EQN. 22)

EQN. 22's solution is then plugged back into EQN. 20, and posterior portfolio weights δₚₒₛₜ=[δₚₒₛₜ^{DW} δₚₒₛₜE]′ (normalized to sum up to one) are obtained by the inversion

δₚₒₛₜ=[[1 1][Ω⁻¹ \tilde{μ}]]⁻¹[Ω⁻¹ \tilde{μ}] (EQN. 23)

The resulting portfolio weights are used to assign new contributions towards the desired retirement income level account (e.g., growth optimal portfolio 108) across the DW equity index and the EM equity index.

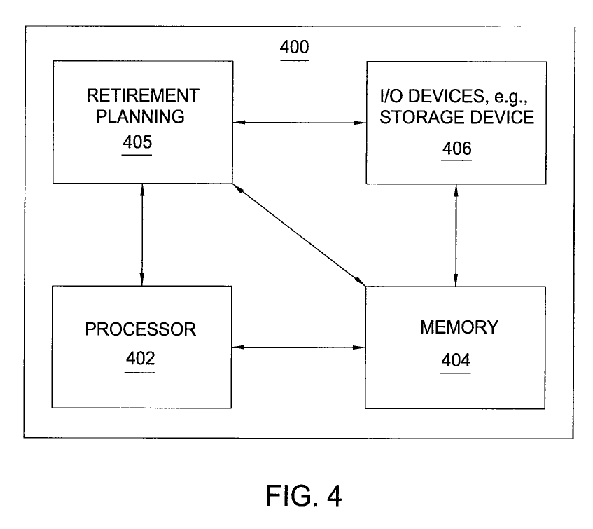

FIG. 4 is a high level block diagram of the present retirement planning tool that is implemented using a general purpose computing device 400. In one embodiment, a general purpose computing device 400 comprises a processor 402, a memory 404, a retirement planning module 405 and various input/output (I/O) devices 406 such as a display, a keyboard, a mouse, a modem, a network connection and the like. In one embodiment, at least one I/O device is a storage device (e.g., a disk drive, an optical disk drive, a floppy disk drive). It should be understood that the retirement planning module 405 can be implemented as a physical device or subsystem that is coupled to a processor through a communication channel.

Alternatively, the retirement planning module 405 can be represented by one or more software applications (or even a combination of software and hardware, e.g., using Application Specific Integrated Circuits (ASIC)), where the software is loaded from a storage medium (e.g., I/O devices 406) and operated by the processor 402 in the memory 404 of the general purpose computing device 400. Additionally, the software may run in a distributed or partitioned fashion on two or more computing devices similar to the general purpose computing device 400. Thus, in one embodiment, the retirement planning module 405 for planning an income stream for retirement described herein with reference to the preceding figures can be stored on a computer readable medium or carrier (e.g., RAM, magnetic or optical drive or diskette, and the like).

Thus, the present invention represents a significant advancement in the field of retirement planning. Embodiments of the invention provide defined benefit-like benefits (e.g., minimized risk) are provided under a defined contribution-like structure (e.g., more individual control). Thus, the beneficial aspects of both defined benefit and defined contribution plans are provided, while the major drawbacks of both plans are substantially minimized.

While the foregoing is directed to embodiments of the invention, other and further embodiments of the invention may be devised without departing from the basic scope thereof.

What is claimed is:

1. A method for defining an income stream for an individual, the method comprising:
in response to receiving lifestyle or personal preferences from the individual, allocating assets belonging to the individual among one or more investments; and
defining a determinable income stream payable to the individual over a period of time in accordance with the allocations of assets.

2. The method of claim 1, wherein the investment preferences include at least one of: a minimum income stream, a target income stream that is at least as great as the minimum income stream, a projected retirement age of the individual and a rate at which the individual wishes to contribute to the one or more investments.

3. The method of claim 1, wherein the allocating comprises:
dedicating a first portion of the assets to one or more investments whose goal is acquisition of a minimum income stream; and
dedicating a second portion of the assets in excess of the first portion to one or more investments whose goal is to minimize variance while maximizing a target income stream that is at least as great as the minimum income stream.

4. The method of claim 3, wherein the first portion of the assets is allocated among one or more inflation-linked fixed income portfolios.

5. The method of claim 3, wherein each of the one or more fixed income portfolios comprises inflation-linked bonds combined with nominal government bonds and inflation derivatives.

6. The method of claim 3, wherein the second portion of the assets is allocated among one or more global equity portfolios.

7. The method of claim 6, wherein each of the one or more global equity portfolios comprises global equity and fixed income.

8. The method of claim 1, wherein the period of time comprises a post-retirement lifespan of the individual.

9. The method of claim 1, wherein the determinable income stream is an inflation-protected annuity.

10. The method of claim 1, wherein the allocating is recalculated on a periodic basis.

11. The method of claim 1, wherein the allocating comprises:
estimating prices for one or more deferred annuities that will pay the determinable income stream over the period of time;
determining a fraction of future contributions from the individual to be dedicated to securing a minimum income stream; and
calculating a probability that the individual will secure a target income stream that is at least as great as the minimum income stream, in accordance with the fraction of future contributions.

12. The method of claim 11, wherein the estimating comprises:
obtaining a model-based price for at least one immediate annuity that will pay the determinable income stream over the period of time.

13. A computer readable medium containing an executable program for defining an income stream for an individual, where the program performs the steps of:
in response to receiving lifestyle or personal preferences from the individual, allocating assets belonging to the individual among one or more investments; and
defining a determinable income stream payable to the individual over a period of time in accordance with the allocations of assets.

14. The computer readable medium of claim 13, wherein the investment preferences include at least one of: a minimum income stream, a target income stream that is at least as great as the minimum income stream, a projected retirement age of the individual and a rate at which the individual wishes to contribute to the one or more investments.

15. The computer readable medium of claim 13, wherein the allocating comprises:
dedicating a first portion of the assets to one or more investments whose goal is acquisition of a minimum income stream; and
dedicating a second portion of the assets in excess of the first portion to one or more investments whose goal is to minimize variance while maximizing a target income stream that is at least as great as the minimum income stream.

16. The computer readable medium of claim 15, wherein the first portion of the assets is allocated among one or more inflation-linked fixed income portfolios.

17. The computer readable medium of claim 15, wherein each of the one or more fixed income portfolios comprises inflation-linked bonds combined with nominal government bonds and inflation derivatives.

18. The computer readable medium of claim 15, wherein the second portion of the assets is allocated among one or more global equity portfolios.

19. The computer readable medium of claim 18, wherein each of the one or more global equity portfolios comprises global equity and fixed income.

20. The computer readable medium of claim 13, wherein the period of time comprises a post-retirement lifespan of the individual.

21. The computer readable medium of claim 13, wherein the determinable income stream is an inflation-protected annuity.

22. The computer readable medium of claim 13, wherein the allocating is recalculated on a periodic basis.

23. The computer readable medium of claim 13, wherein the allocating comprises:
estimating prices for one or more deferred annuities that will pay the determinable income stream over the period of time;
determining a fraction of future contributions from the individual to be dedicated to securing a minimum income stream; and
calculating a probability that the individual will secure a target income stream that is at least as great as the minimum income stream, in accordance with the fraction of future contributions.

24. The computer readable medium of claim 23, wherein the estimating comprises:
obtaining a model-based price for at least one immediate annuity that will pay the determinable income stream over the period of time.

25. A system for defining an income stream for an individual, the system comprising:
means for, in response to receiving lifestyle or personal preferences from the individual, allocating assets belonging to the individual among one or more investments; and
means for defining a determinable income stream payable to the individual over a period of time in accordance with the allocations of assets.
